(19) United States
(12) Patent Application Publication
(10) Pub. No.: US 2021/0020921 A1
(43) Pub. Date: Jan. 21, 2021

(54) BATTERY CELL AND BATTERY USING THE SAME

(71) Applicant: Ningde Amperex Technology Ltd., Ningde (CN)

(72) Inventors: YI-BO ZHANG, Ningde (CN); Qiaoshu Hu, Ningde (CN); Bin Wang, Ningde (CN); Li Xiang, Ningde (CN)

(21) Appl. No.: 16/549,144

(22) Filed: Aug. 23, 2019

(30) Foreign Application Priority Data
Jul. 19, 2019 (CN) 201910657451.5

(51) Int. Cl. H01M 4/36; H01M 10/052; H01M 4/38; H01M 4/04; H01M 4/1395

(52) U.S. Cl. CPC H01M 4/366; H01M 10/052; H01M 4/1395; H01M 4/0423; H01M 4/382

(57) ABSTRACT

A battery cell includes at least one electrode plate. The electrode plate includes a composite current collector having an ionic conductive material and two active material layers disposed on the composite current collector. The active material layers include a positive active material layer and a negative active material layer. The composite current collector is disposed between the positive active material layer and the negative active material layer. Each of the positive active material layer and the negative active material layer is connected to the ionic conductive material. The battery cell is a multilayered structure formed by folding a single electrode plate upon itself or by stacking the electrode plates together, adjacent active material layers in two adjacent layers of the battery cell are of a same polarity. A battery using the battery cell is also provided.

### FIELD

The subject matter herein generally relates to a battery cell and a battery using the battery cell.

### BACKGROUND

Due to high energy density, high operating voltage, low self-discharge, small volume, and light weight, lithium batteries are widely used in consumer electronics. With the rapid development of electric vehicles and mobile devices, safety of such a lithium battery has become a great concern.

A lithium battery may use a metallic foil, such as copper foil, aluminum foil, or nickel foil, as a current collector. The lithium battery may also use a composite current collector, which can decrease the weight and increase the energy density of the lithium battery. However, the design of such a battery still has certain limitations. Improving the energy density of the battery cell is problematic.

### SUMMARY

What is needed, is a battery cell having improved energy density and a battery including the battery cell.

The present disclosure provides a battery cell including an electrode plate. The electrode plate includes a composite current collector including an ionic conductive material and two active material layers disposed on the composite current collector. The two active material layers includes a positive active material layer and a negative active material layer, the composite current collector being disposed between the positive active material layer and the negative active material layer, each of the positive active material layer and the negative active material layer being connected to the ionic conductive material. Wherein the battery cell is a multilayered structure formed by folding a single electrode plate or by stacking a plurality of the electrode plates together, adjacent active material layers in two adjacent layers of the battery cell are of a same polarity.

In at least one embodiment, the battery cell further includes a plurality of first channels passing through the composite current collector. Wherein the ionic conductive material fills in the plurality of first channels.

In at least one embodiment, the plurality of first channels further pass through the positive active material layer and the negative active material layer.

In at least one embodiment, an average diameter of the plurality of first channels is between 50 micrometers and 5000 micrometers.

In at least one embodiment, a density of the plurality of first channels on the composite current collector is between 1 /m² and 1000 /m².

In at least one embodiment, a ratio of areas of the plurality of first channels with respect to an area of the composite current collector is between 2% and 40%.

In at least one embodiment, the composite current collector includes an insulating layer, a first conductive layer, and a second conductive layer, the insulating layer being disposed between the first conductive layer and the second conductive layer. Wherein the positive active material layer is connected to a surface of the first conductive layer away from the insulating layer, and the negative active material layer is connected to a surface of the second conductive layer away from the insulating layer.

In at least one embodiment, the insulating layer includes the ionic conductive material, each of the first conductive layer and the second conductive layer includes a plurality of second channels. The positive active material layer and the negative active material layer fill in the plurality of second channels and further connect the insulating layer.

In at least one embodiment, the battery cell is formed by folding the single electrode plate, and the battery cell is S-shaped.

In at least one embodiment, the battery cell further includes a plurality of connecting sections each disposed between two adjacent active material layers, wherein the plurality of connecting sections include no active material layer.

In at least one embodiment, the battery cell includes a plurality of electrode plates which are stacked together.

In at least one embodiment, the ionic conductive material is selected from a group consisting of poly(vinylidene fluoride-hexafluoropropylene), polyvinylidene fluoride, polyacrylonitrile, polymethyl methacrylate, polyphenylene oxide, poly propylene carbonate, polyethylene oxide, and derivatives thereof.

The present disclosure further provides a battery cell including the above battery cell, an electrolyte, and a package casing configured for receiving the battery cell and the electrolyte.

In the present disclosure, the ionic conductive material is added in the composite current collector. Since the ionic conductive material can conduct ions and isolate electrons, ion channels can be generated between the active material layers of the composite current collector. Furthermore, since adjacent active material layers in two adjacent layers of the battery cell are of the same polarity, an isolation film can be omitted, which can further increase the energy density and reduce the cost of the battery cell.

### BRIEF DESCRIPTION OF THE DRAWINGS

Implementations of the present disclosure will now be described, by way of embodiments, with reference to the attached figures.

FIG. 1 is a plan view of an embodiment of a battery cell according to the present disclosure.

FIG. 2 is a cross-sectional view of an embodiment of an electrode plate of the battery cell of FIG. 1 taken long line II-II.

FIG. 3 is a cross-sectional view of another embodiment of an electrode plate of the battery cell of FIG. 1 taken long line II-II.

FIG. 4 is a cross-sectional view of yet another embodiment of an electrode plate of the battery cell of FIG. 1 taken long line II-II.

FIG. 5 is a plan view of another embodiment of a battery cell according to the present disclosure.

FIG. 6 is a block diagram of an embodiment of a battery according to the present disclosure.

### DETAILED DESCRIPTION

Implementations of the disclosure will now be described, by way of embodiments only, with reference to the drawing. The disclosure is illustrative only, and changes may be made in the detail within the principles of the present disclosure. It will, therefore, be appreciated that the embodiments may be modified within the scope of the claims.

Unless otherwise defined, all technical terms used herein have the same meaning as commonly understood by one of ordinary skill in the art. The technical terms used herein is to provide a thorough understanding of the embodiments described herein, but not to be considered as limiting the scope of the embodiments.

Implementations of the disclosure will now be described, by way of embodiments only, with reference to the drawing. It should be noted that non-conflicting details and features in the embodiments of the present disclosure may be combined with each other.

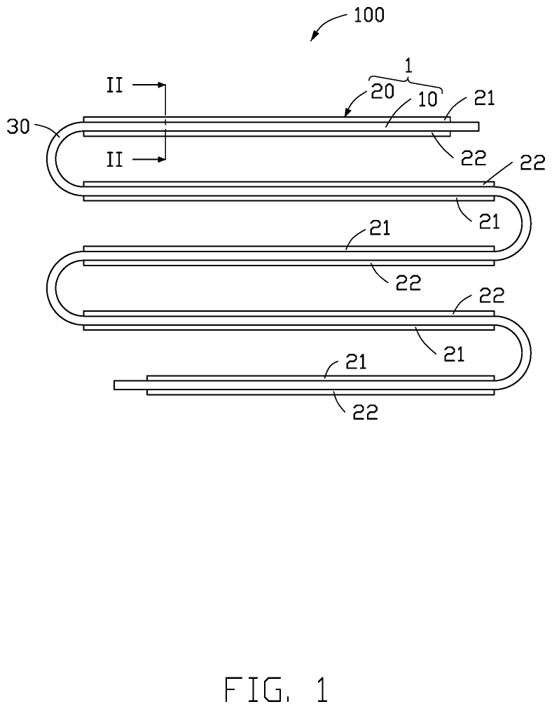

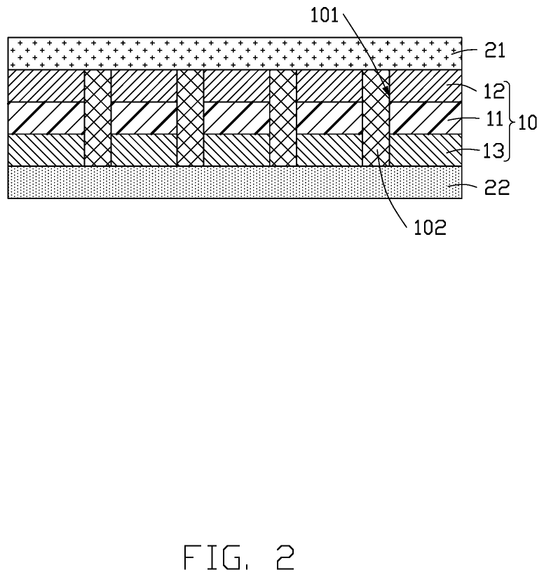

FIGS. 1 and 2 illustrate an embodiment of a battery cell 100 including an electrode plate 1. The electrode plate 1 includes a composite current collector 10 and two active material layers 20 disposed on the composite current collector 10. The composite current collector 10 includes an ionic conductive material 102. The active material layers 20 include a positive active material layer 21 and a negative active material layer 22. The composite current collector 10 is disposed between the positive active material layer 21 and the negative active material layer 22. Each of the positive active material layer 21 and the negative active material layer 22 is connected to the ionic conductive material 102. The battery cell 100 is a multilayered structure formed by folding the single electrode plate 1 or by stacking electrode plates 1 together. Adjacent active material layers 20 in two adjacent layers of the battery cell 100 are of the same polarity, that is, they are both either the positive active material layer 21 or the negative active material layer 22.

In at least one embodiment, the ionic conductive material 102 can be selected from a group consisting of poly(vinylidene fluoride-hexafluoropropylene) (PVDF-HFP), polyvinylidene fluoride (PVDF), polyacrylonitrile (PAN), polymethyl methacrylate (PMMA), polyphenylene oxide (PPO), poly propylene carbonate (PPC), polyethylene oxide (PEO), and derivatives thereof.

In the present disclosure, the ionic conductive material 102 is added in the composite current collector 10. Since the ionic conductive material 102 can conduct ions and isolate electrons, ion channels can be generated between the active material layers 20 (that is, the positive active material layer 21 and the negative active material layer 22) of the composite current collector 10. Furthermore, since adjacent active material layers 20 in two adjacent layers of the battery cell 100 are both either the positive active material layer 21 or the negative active material layer 22 (that is, of the same polarity), an isolation film can be omitted, which can further increase the energy density and reduce the cost of the battery cell 100. Moreover, by coating positive and negative active materials on opposite sides of the composite current collector 10, the existing positive and negative electrode plates are combined together to form a single electrode plate 1. Thus, the battery cell 100 can be formed by folding the single electrode plate 1 or by stacking electrode plates 1 together. The manufacturing process is simplified, the manufacturing efficiency is increased, and the cost is reduced.

The positive active material layer 21 and the negative active material layer 22 can be formed by coating active materials on the composite current collector 10 and drying and cold pressing the coating of active materials. The composite current collector 10 can include primary coating layers (not shown) on the surfaces thereof. The primary coating layer includes a conductive material (such as carbon nanotubes, conductive carbon, or graphene) and a binding agent. The primary coating layer can further increase the number of ion channels on the surface of the electrode plate 1 and the electrochemical performance, and increase the bonding strength between the active material and the composite current collector 10.

Referring to FIG. 2, the battery cell 100 further includes a plurality of first channels 101 passing through the composite current collector 10. The ionic conductive material 102 fills in each of the first channels 101.

In at least one embodiment, the composite current collector 10 includes an insulating layer 11, a first conductive layer 12, and a second conductive layer 13. The insulating layer 11 is disposed between the first conductive layer 12 and the second conductive layer 13. The positive active material layer 21 is connected to a surface of the first conductive layer 12 facing away from the insulating layer 11. The negative active material layer 22 is connected to a surface of the second conductive layer 13 facing away from the insulating layer 11. The first channels 102 pass through the insulating layer 11, the first conductive layer 12, and the second conductive layer 13. Furthermore, electrode tabs (not shown) can be connected to the top portions of the first conductive layer 12 and the second conductive layer 13 by welding. The electrode tabs can conduct electrons from the first conductive layer 12 and the second conductive layer 13. At this time, the composite current collector 10 is double-sided and has a smaller thickness compared to the existing current collector made of metal foil, which may be advantageous for the increase of energy density per unit volume. Furthermore, the insulating layer 11 of the composite current collector 10 is more flexible and malleable, fractures during manufacture are greatly reduced. The composite current collector 10 also has less weight compared to that of the existing current collector, which can increase the energy density per unit mass. The composite current collector 10 also has less volume compared to that of the existing current collector, which can increase the energy density per unit volume. The safety of the battery cell 100 can also be improved.

In at least one embodiment, each of the first channels 101 is also filled with inorganic particles and an adhesive agent (not shown). The inorganic particles and the adhesive agent ensure electron isolation of the composite current collector 10, and further provide gaps through which electrolyte can penetrate to facilitate the conduction of ions.

The inorganic particles can be made of a material selected from a group consisting of oxide, hydroxide, lithium compound, and any combination thereof. Specifically, the oxide can be selected from a group consisting of HfO₂, SrTiO₃, SnO₂, CeO₂, MgO, NiO, CaO, BaO, ZnO, ZrO₂, Y₂O₃, Al₂O₃, TiO₂, SiO₂, and any combination thereof. The hydroxide can be selected from a group consisting of boehmite, magnesium hydroxide, aluminium hydroxide, and any combination thereof. The lithium compound can be selected from a group consisting of lithium phosphate (Li₃PO₄), lithium titanium phosphate (LiₓTi_{y}(PO₄)₃, wherein 0<x<2, 0<y<3), lithium aluminum titanium phosphate (LiₓAl_{y}Ti_{z}(PO₄)₃, wherein 0<x<2, 0<y<1, 0<z<3), Li_{1+x+y}(Al,Ga)ₓ (Ti,Ge)₂₋ₓSi_{y}P_{3-y}O₁₂ (wherein 0≤x≤1, 0≤y≤1), lithium lanthanum titanate (LiₓLa_{y}TiO₃, wherein 0<x<2, 0<y<3), lithium germanium thiophosphate (LiₓGe_{y}P_{z}S_{w}, wherein 0<x<4, 0<y<1, 0<z<1, 0<w<5), lithium nitride (LiₓN_{y}, wherein 0<x<4, 0<y<2), SiS₂ glass(LiₓSi_{y}S_{z}, wherein 0≤x<3, 0<y<2, 0<z<4), P₂S₅ glass (LiₓP_{y}S_{z}, wherein 0≤x<3, 0<y<3, 0<z<7), Li₂O, LiF, LiOH, Li₂CO₃, LiAlO₂, Li₂O—Al₂O₃—SiO₂—P₂O₅—TiO₂—GeO₂ ceramic, garnet ceramic (Li₃₊ₓLa₃M₂O12, wherein 0≤x≤5, M can be Te, Nb, or Zr), and any combination thereof.

The adhesive agent can be made of a material selected from a group consisting of polyamide, polyurethane, ethylene-vinyl acetate copolymer (EVA), ethylene vinyl alcohol copolymer (EVOH), acrylic ester, sodium alginate (SA), polyacrylic acid (PAA), polyvinyl alcohol (PVA), carboxymethyl chitosan, gelatin, PVDF-HFP, PVDF, PAN, PMMA, PPO, PPC, PEO, and derivatives thereof. In at least one embodiment, the adhesive agent can be made of a polymer electrolyte which can conduct ions, such as PVDF-HFP, PVDF, PAN, PMMA, PPO, PPC, PEO, and derivatives thereof.

In at least one embodiment, the average diameter of the first channels 101 is between 50 micrometers and 5000 micrometers. When the average diameter of the first channels 101 is greater than or equal to 50 micrometers, the ion conducting performance of each first channel 101 is ensured. When the average diameter of the first channels 101 is less than or equal to 5000 micrometers, undesirable effects on the electron channels adjacent to the first channels 101 are avoided. Thus, the electron conducting performance of the first conductive layer 12 and the second conductive layer 13 can be ensured.

The density of the first channels 101 on the composite current collector 10 is between 1/m² and 1000/m². That is, the number of the first channels 101 per square meter of the composite current collector 10 is between 1 and 1000. When the density of the first channels 101 is greater than or equal to 1/m², the ion conducting performance of each first channel 101 can be ensured, which allows the active materials away from the first channels 101 to obtain effective ion channels. When the density of the first channels 101 is less than or equal to 1000 /m², undesirable effects on the electron channels adjacent to the first channels 101 are avoided. Thus, the electron conducting performance of the first conductive layer 12 and the second conductive layer 13 can be ensured.

The ratio of the areas of the first channels 101 with respect to the area of the composite current collector 10 is between 2% and 40%. When the ratio is greater than or equal to 2%, the ion conducting performance of each first channel 101 can be ensured. When the ratio is less than or equal to 40%, undesirable effects on the electron channels adjacent to the first channels 101 are avoided. Thus, the electron conducting performance of the first conductive layer 12 and the second conductive layer 13 can be ensured.

Furthermore, the insulating layer 11 can be made of polymers. Specifically, the insulating layer 11 can be made of poly(butylene terephthalate), poly(ethylene naphthalate) (PEN), poly-ether-ether-ketone, polyimide, polyamide, polyethylene glycol, polyamide imide, polycarbonate, cyclic polyolefin, polyphenylene sulfide, polyvinyl acetate, poly tetra fluoroethylene, polynaphthylmethylene, polyvinylidene difluoride, poly(naphthalenedicarboxylicacid), poly propylene carbonate, poly(vinylidene difluoride-co-hexafluoropropylene), poly(vinylidene difluoride-co-chlorotrifluoroethylene), polysiloxane, vinylon, polypropylene, polyethylene, polyvinyl chloride, polystyrene, poly(cyanoarylether), polyurethane, polyphenylene oxide, polyester, polysulfone, and derivatives thereof.

The porosity of the insulating layer 11 is less than or equal to 50%. The pores of the insulating layer 11 decrease the weight of the composite current collector 10 and increase the loading amount of the effective materials. The surface area of the composite current collector 10 is also increased, which increases the number of the ion channels (that is, the insulating layer 11 has larger surface area covered by the conductive layer when the conductive layer is formed on the insulating layer 11). Furthermore, when the porosity of the insulating layer 11 is less than or equal to 50%, the insulating layer 11 prevents the first conductive layer 12 and the second conductive layer 13 from permeating into and connecting to each other.

The thickness of the insulating layer 11 is 1 micrometer to 20 micrometers. When the thickness of the insulating layer 11 is less than or equal to 20 micrometers, the composite current collector 10 can have a total thickness no more than the thickness of the existing current collector. Thus, energy density of the battery cell 100 is not reduced. When the thickness of the insulating layer 11 is greater than or equal to 1 micrometer, the insulating layer 11 has higher mechanical strength and better prevention of contact between the first conductive layer 12 and the second conductive layer 13.

Furthermore, the first conductive layer 12 and the second conductive layer 13 can be formed by sputtering, vacuum vapor deposition, ion plating, or pulse laser deposition. Since only the insulating layer 11 needs to be cut, metal burrs are avoided, the voltage drop within per unit time (K value) is reduced, and the safety of the battery is improved. The first conductive layer 12 and the second conductive layer 13 can be made of a material selected from a group consisting of Ni, Ti, Cu, Ag, Au, Pt, Fe, Co, Cr, W, Mo, Al, Mg, K, Na, Ca, Sr, Ba, Si, Ge, Sb, Pb, In, Zn, and any combination (alloy) thereof. The first conductive layer 12 and the second conductive layer 13 can be made of different materials. In at least one embodiment, the first conductive layer 12 is made of Cu, and the second conductive layer 13 is made of Al. That is, the composite current collector 10 have different materials on opposite surfaces of the insulating layer 11. In other embodiments, the first conductive layer 12 and the second conductive layer 13 can also be made of a same material, for example, the first conductive layer 12 and the second conductive layer 13 are both made of Ni.

The porosity of each of the first conductive layer 12 and the second conductive layer 13 is less than or equal to 60%. The pores of the first conductive layer 12 and the second conductive layer 13 decrease the weight of the composite current collector 10 and increase the loading amount of the effective material. Furthermore, when the porosity of each of the first conductive layer 12 and the second conductive layer 13 is less than or equal to 60%, the electron channels of the first conductive layer 12 and the second conductive layer 13 will not be elongated (elongation of the electron channels can affect the conducting capability of the electrons and reduce the performance of the battery cell 100).

The thickness of each of the first conductive layer 12 and the second conductive layer 13 is between 0.1 micrometer and 10 micrometers. When the thickness of each of the first conductive layer 12 and the second conductive layer 13 is less than or equal to 10 micrometers, the composite current collector 10 can have a total thickness no more than the thickness of the existing current collector. Thus, the energy density of the battery cell 100 can be ensured, and the manufacturing efficiency can be increased. Furthermore, when the thickness of each of the first conductive layer 12 and the second conductive layer 13 is greater than or equal to 0.1 micrometer, the first conductive layer 12 and the second conductive layer 13 can have a high performance in conducting electrons to ensure the performance of the battery cell 100.

A ratio of the thickness of the insulating layer 11 with respect to the thickness of the first conductive layer 12 or the second conductive layer 13 is between 0.1 and 400.

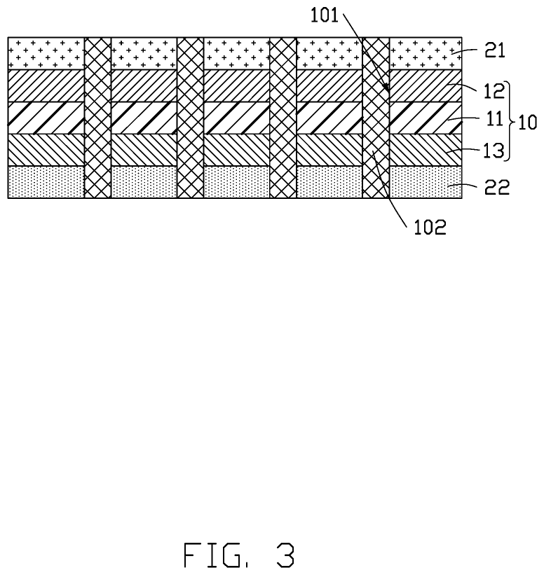

Referring to FIG. 3, in another embodiment, the first channels 101 can further pass through the positive active material layer 21 and the negative active material layer 22. During manufacturing, after the positive and negative active materials are coated on opposite sides of the composite current collector 10, the first channels 101 are defined, which pass through the composite current collector 10, the positive active material layer 21, and the negative active material layer 22.

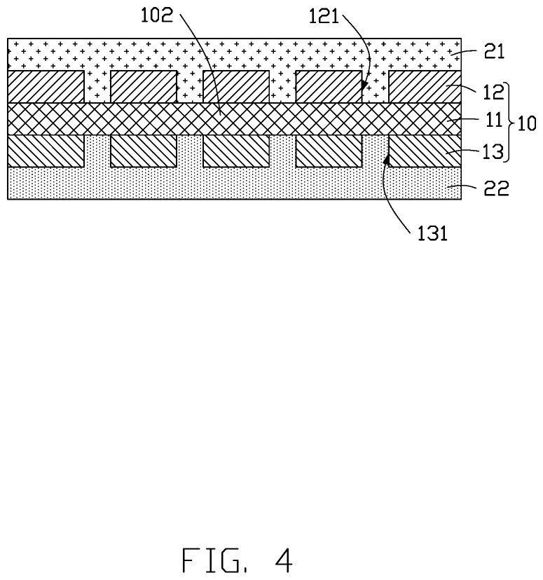

Referring to FIG. 4, in other embodiments, the insulating layer 11 includes the ionic conductive material 102. For example, the insulating layer 11 is made entirely of the ionic conductive material 102. The first conductive layer 12 and the second conductive layer 13 include a plurality of second channels 121 and 131, respectively. The positive active material layer 21 and the negative active material layer 22 further fill in the second channels 121 and 131, respectively, and further connect the insulating layer 11. During manufacturing, a plate (not shown) first covers a portion of the insulating layer 11. The first conductive layer 12 and the second conductive layer 13 are coated on the uncovered portions of the insulating layer 11, causing the second channels 121, 131 to be formed in the first conductive layer 12 and the second conductive layer 13 when the plate is removed. Then, the positive and negative active materials are coated on the first conductive layer 12 and the second conductive layer 13.

As shown in FIG. 1, the battery cell 100 is formed by folding the single electrode plate 1 into serpentine form. The battery cell 100 is substantially S-shaped. The battery cell 100 further includes a plurality of connecting sections 30 each disposed between adjacent active material layers 20. The connecting sections 30 includes no active material layer 20. That is, the connecting sections 30 include blank areas at opposite sides. Thus, the active material at corners of the electrode plate 1 can be prevented from falling off. The width of the battery cell 100 can be reduced, and the cycling retention capacity of the battery cell 100 can further be increased.

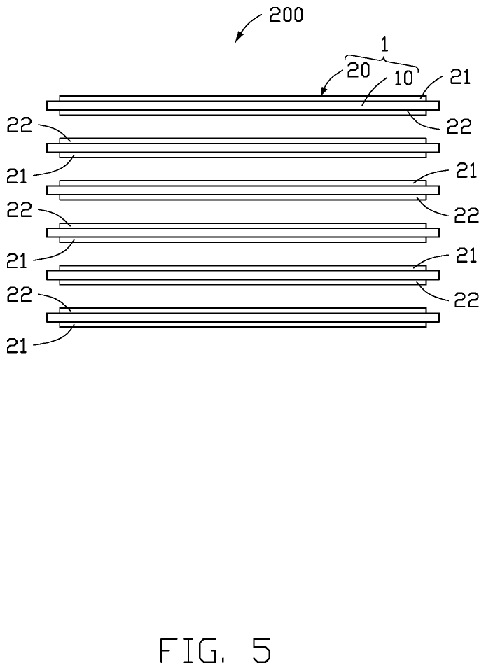

Referring to FIG. 5, the present disclosure further provides a battery cell 200. Different from the battery cell 100, the battery cell 200 includes a plurality of electrode plates 1 which are stacked together.

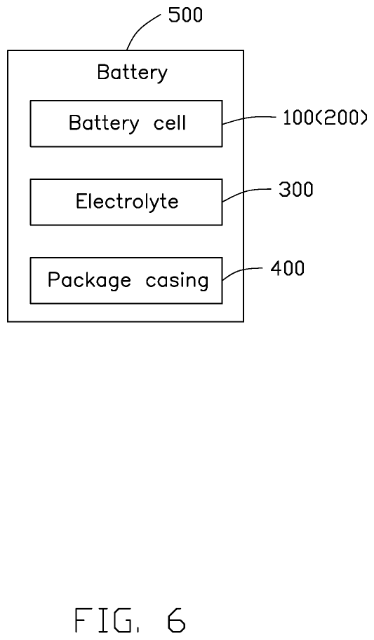

Referring to FIG. 6, the present disclosure further provides a battery 500 including a battery cell 100 or 200, an electrolyte 300, and a package casing 400. The package casing 400 can receive the battery cell 100 or 200 and the electrolyte 300 therein. In manufacture, the battery cell 100 or 200 is filled with electrolyte, then encapsulated and formatted to obtain the finished battery 500.

The present disclosure will be described below by way of different embodiments and comparative embodiments.

### EMBODIMENT 1

Preparation of composite current collector (having different materials on opposite surfaces of the insulating layer): Cu layer (thickness of 0.5 micrometers) and Al layer (thickness of 0.5 micrometers) were formed on two opposite surfaces of the PET film (thickness of 12 micrometers) by vacuum vapor deposition. Then, first channels were uniformly defined at the composite current collector by high energy laser. The first channels had an average diameter of 50 micrometers. The density of the first channels on the composite current collector was 1000 /m². The ratio of the areas of first channels relative to the area of the composite current collector was 2%. A PVDF plate was disposed at a surface of the composite current collector, to allow the PVDF plate and the composite current collector to fully connect to each other at the connecting surfaces. PVDF was added into N-methylpyrrolidone (NMP) to obtain a slurry with a solid content of 50%. The slurry was stirred and then uniformly formed on the metallic layer disposed at the opposite surface of the composite current collector by blade coating, and dried at 90 degrees Celsius. The remaining PVDF on the composite current collector was washed by ethyl acetate. The PVDF plate was removed, thereby obtaining the composite current collector having different materials on opposite surfaces of the insulating layer.

Preparation of electrode plate: LiCoO₂, Super P, and PVDF, in a ratio of 97.5:1.0:1.5 by weight, were mixed to form the positive active material. NMP was added into the positive active material to form a slurry with a solid content of 75%. The slurry was stirred and then uniformly coated on the Al layer of the composite current collector, dried at 90 degrees Celsius, and cold pressed to form the positive active material layer.

Graphite, Super P, and styrene butadiene rubber (SBR), in a ratio of 96:1.5:2.5 by weight, were mixed to form the negative active material. Deionized water was added into the negative active material to form a slurry with a solid content of 70%. The slurry was stirred and then coated on the Cu layer of the composite current collector, dried at 110 degrees Celsius, and cold pressed to form the negative active material layer. Electrode tabs were connected to the composite current collector, and adhesive was applied to the electrode tabs. Thus the electrode plate was obtained.

Preparation of electrolyte: ethylene carbonate (EC), ethyl methyl carbonate (EMC), and diethyl carbonate (DEC), in a ratio of 30:50:20 by weight, were mixed to form an organic solvent, and lithium hexafluorophosphate (LiPF₆) was uniformly dissolved in the organic solvent, thereby obtaining the electrolyte. The LiPF₆ in the electrolyte has a concentration of 1.15M.

Preparation of lithium battery: the electrode plate was folded into serpentine form to form the battery cell, causing adjacent active material layers of two adjacent layers of the battery cell to both be the positive active material layers or the negative active material layers. The battery cell was filled with electrolyte and encapsulated. The battery cell was further formatted, through 0.2C (constant current) charging to 3.3V and 0.1C (constant current) charging to 3.6V, and then tested. The soft pack lithium battery was thus obtained.

### EMBODIMENT 2

Preparation of composite current collector (having different materials on opposite surfaces of the insulating layer): steps were almost the same as those of the embodiment 1. Differences were that the first channels of embodiment 2 had an average diameter of 500 micrometers, the density of the first channels on the composite current collector was 60 /m², and the ratio of the areas of first channels relative to the area of the composite current collector was 12%.

Preparation of electrode plate: steps were the same as those of the embodiment 1.

Preparation of electrolyte: steps were the same as those of the embodiment 1.

Preparation of lithium battery: steps were the same as those of the embodiment 1.

### EMBODIMENT 3

Preparation of composite current collector (having different materials on opposite surfaces of the insulating layer): steps were almost the same as those of the embodiment 1. Differences were that the first channels of embodiment 3 had an average diameter of 2000 micrometers, the density of the first channels on the composite current collector was 10 /m², and the ratio of the areas of first channels relative to the area of the composite current collector was 31%.

Preparation of electrode plate: steps were the same as those of the embodiment 1.

Preparation of electrolyte: steps were the same as those of the embodiment 1.

Preparation of lithium battery: steps were the same as those of the embodiment 1.

### EMBODIMENT 4

Preparation of composite current collector (having different materials on opposite surfaces of the insulating layer): steps were almost the same as those of the embodiment 1. Differences were that the first channels of embodiment 4 had an average diameter of 5000 micrometers, the density of the first channels on the composite current collector was 2 /m², and the ratio of the areas of first channels relative to the area of the composite current collector was 39%.

Preparation of electrode plate: steps were the same as those of the embodiment 1.

Preparation of electrolyte: steps were the same as those of the embodiment 1.

Preparation of lithium battery: steps were the same as those of the embodiment 1.

### EMBODIMENT 5

Preparation of composite current collector (having different materials on opposite surfaces of the insulating layer): steps were almost the same as those of the embodiment 1. Differences were that the first channels of embodiment 5 had an average diameter of 2000 micrometers, the density of the first channels on the composite current collector was 1 /m², and the ratio of the areas of first channels relative to the area of the composite current collector was 3.1%.

Preparation of electrode plate: steps were the same as those of the embodiment 1.

Preparation of electrolyte: steps were the same as those of the embodiment 1.

Preparation of lithium battery: steps were the same as those of the embodiment 1.

### EMBODIMENT 6

Preparation of composite current collector (having different materials on opposite surfaces of the insulating layer): steps were almost the same as those of the embodiment 1. Differences were that the first channels of embodiment 6 had an average diameter of 1000 micrometers, the density of the first channels on the composite current collector was 20 /m², and the ratio of the areas of first channels relative to the area of the composite current collector was 16%.

Preparation of electrode plate: steps were the same as those of the embodiment 1.

Preparation of electrolyte: steps were the same as those of the embodiment 1.

Preparation of lithium battery: steps were the same as those of the embodiment 1.

### EMBODIMENT 7

Preparation of composite current collector (having different materials on opposite surfaces of the insulating layer): steps were almost the same as those of the embodiment 1. Differences were that the first channels of embodiment 7 had an average diameter of 500 micrometers, the density of the first channels on the composite current collector was 100 /m², and the ratio of the areas of first channels relative to the area of the composite current collector was 20%.

Preparation of electrode plate: steps were the same as those of the embodiment 1.

Preparation of electrolyte: steps were the same as those of the embodiment 1.

Preparation of lithium battery: steps were the same as those of the embodiment 1.

### EMBODIMENT 8

Preparation of composite current collector (having different materials on opposite surfaces of the insulating layer): steps were almost the same as those of the embodiment 1. Differences were that the first channels of embodiment 8 had an average diameter of 1600 micrometers, the density of the first channels on the composite current collector was 1 /m², and the ratio of the areas of first channels relative to the area of the composite current collector was 2%.

Preparation of electrode plate: steps were the same as those of the embodiment 1.

Preparation of electrolyte: steps were the same as those of the embodiment 1.

Preparation of lithium battery: steps were the same as those of the embodiment 1.

### EMBODIMENT 9

Preparation of composite current collector (having different materials on opposite surfaces of the insulating layer): steps were almost the same as those of the embodiment 1. Differences were that the first channels of embodiment 9 had an average diameter of 1600 micrometers, the density of the first channels on the composite current collector was 4 /m², and the ratio of the areas of first channels relative to the area of the composite current collector was 8%.

Preparation of electrode plate: steps were the same as those of the embodiment 1.

Preparation of electrolyte: steps were the same as those of the embodiment 1.

Preparation of lithium battery: steps were the same as those of the embodiment 1.

### EMBODIMENT 10

Preparation of composite current collector (having different materials on opposite surfaces of the insulating layer): steps were almost the same as those of the embodiment 1. Differences were that the first channels of embodiment 10 had an average diameter of 1600 micrometers, the density of the first channels on the composite current collector was 12 /m², and the ratio of the areas of first channels relative to the area of the composite current collector was 24%.

Preparation of electrode plate preparation: steps were the same as those of the embodiment 1.

Preparation of electrolyte: steps were the same as those of the embodiment 1.

Preparation of lithium battery: steps were the same as those of the embodiment 1.

### EMBODIMENT 11

Preparation of composite current collector (having different materials on opposite surfaces of the insulating layer): steps were almost the same as those of the embodiment 1. Differences were that the first channels of embodiment 11 had an average diameter of 1600 micrometers, the density of the first channels on the composite current collector was 20 /m², and the ratio of the areas of first channels relative to the area of the composite current collector was 40%.

Preparation of electrode plate: steps were the same as those of the embodiment 1.

Preparation of electrolyte: steps were the same as those of the embodiment 1.

Preparation of lithium battery: steps were the same as those of the embodiment 1.

### EMBODIMENT 12

Preparation of composite current collector (having different materials on opposite surfaces of the insulating layer): steps were the same as those of the embodiment 6. Differences were that PAN was added into NMP to obtain a slurry with a solid content of 50%. That is, the ionic conductive material in the first channels was PAN.

Preparation of electrode plate: steps were the same as those of the embodiment 6.

Preparation of electrolyte: steps were the same as those of the embodiment 6.

Preparation of lithium battery: steps were the same as those of the embodiment 6.

### EMBODIMENT 13

Preparation of composite current collector (having different materials on opposite surfaces of the insulating layer): steps were almost the same as those of the embodiment 6. Differences were that PEO was added into NMP to obtain a slurry with a solid content of 60%. That is, the ionic conductive material in the first channels was PEO.

Preparation of electrode plate: steps were the same as those of the embodiment 6.

Preparation of electrolyte: steps were the same as those of the embodiment 6.

Preparation of lithium battery: steps were the same as those of the embodiment 6.

### EMBODIMENT 14

Preparation of composite current collector (having different materials on opposite surfaces of the insulating layer): steps were the same as those of the embodiment 6. Differences were that Al₂O₃ particles and PVDF were simultaneously added into NMP to obtain a slurry with a solid content of 70%. That is, the Al₂O₃ particles and the PVDF were in a ratio of 95:5 by weight.

Preparation of electrode plate: steps were the same as those of the embodiment 6.

Preparation of electrolyte: steps were the same as those of the embodiment 6.

Preparation of lithium battery: steps were the same as those of the embodiment 6.

### EMBODIMENT 15

Preparation of composite current collector (having different materials on opposite surfaces of the insulating layer): Cu layer (thickness of 0.5 micrometers) and Al layer (thickness of 0.5 micrometers) were formed on two opposite surfaces of the PET film (thickness of 12 micrometers) by vacuum vapor deposition. The Cu layer and the Al layers respectively functioned as the negative current collector and the positive current collector.

Preparation of electrode plate: steps were almost the same as those of the embodiment 6. Differences were that after the electrode tabs were connected to the composite current collector and adhesive was applied to the electrode tabs of embodiment 15, first channels were uniformly defined at the composite current collector by high energy laser. The first channels had an average diameter of 1000 micrometers. The density of the first channels on the composite current collector was 20 /m². The ratio of the areas of first channels relative to the area of the composite current collector was 16%. A PVDF plate was disposed at a surface of the composite current collector, to allow the PVDF plate and the composite current collector to fully connect to each other at the connecting surfaces. PVDF was added into NMP to obtain a slurry with a solid content of 50%. The slurry was stirred and then uniformly formed on the metallic layer disposed at the opposite surface of the composite current collector by blade coating, causing the slurry to infill the first channels, and dried at 90 degrees Celsius. The PVDF plate was removed, thereby obtaining the electrode plate.

Preparation of electrolyte: steps were the same as those of the embodiment 6.

Preparation of lithium battery: steps were the same as those of the embodiment 6.

### EMBODIMENT 16

Preparation of composite current collector (having different materials on opposite surfaces of the insulating layer): steps were the same as those of the embodiment 6.

Preparation of electrode plate: steps were almost the same as those of the embodiment 6. Differences were that before coating the positive and negative active materials in embodiment 16, primary coating layers were first formed. Specifically, Super P and SBR, in a ratio of 95:5 by weight, were mixed. Deionized water was added to form a slurry with a solid content of 80%. The slurry was stirred and then uniformly coated on the Cu layer of the composite current collector, dried at 110 degrees Celsius, and cold pressed to form the primary coating layer on the Cu layer. Moreover, Super P and SBR, in a ratio of 97:3 by weight, were mixed. Deionized water was added to form a slurry with a solid content of 85%. The slurry was stirred and then uniformly coated on the Al layer of the composite current collector, dried at 110 degrees Celsius, and cold pressed to form the primary coating layer on the Al layer.

Preparation of electrolyte: steps were the same as those of the embodiment 6.

Preparation of lithium battery: steps were the same as those of the embodiment 6.

### EMBODIMENT 17

Preparation of composite current collector (having different materials on opposite surfaces of the insulating layer): steps were the same as those of the embodiment 6.

Preparation of electrode plate: steps were almost the same as those of the embodiment 6. Difference were that the slurry of embodiment 17 was intermittently coated on the Cu and Al layers, thereby causing the electrode plate to have a number of blank areas at opposite sides.

Preparation of electrolyte: steps were the same as those of the embodiment 6.

Preparation of lithium battery: steps were almost the same as those of the embodiment 6. Difference were that the blank areas in embodiment 17 were disposed at the corners of the battery cell after the folding.

### EMBODIMENT 18

Preparation of composite current collector (having different materials on opposite surfaces of the insulating layer): steps were the same as those of the embodiment 6.

Preparation of electrode plate: steps were almost the same as those of the embodiment 6. Difference were that the electrode plate in embodiment 18 was cut to a preset size (41 mm×61 mm).

Preparation of electrolyte: steps were the same as those of the embodiment 6.

Preparation of lithium battery: the electrode plates were stacked to form the battery cell, causing adjacent active material layers of two adjacent layers of the battery cell to both be the positive active material layers or the negative active material layers. The four corners of the stacked structure were fixed in an aluminum package film through an adhesive tape. The battery cell was filled with electrolyte and encapsulated. The battery cell was further formatted, through 0.2 C (constant current) charging to 3.3V and 0.1C (constant current) charging to 3.6V, and then tested. The soft pack lithium battery was thus obtained.

### EMBODIMENT 19

Preparation of composite current collector (having different materials on opposite surfaces of the insulating layer): Cu layer (thickness of 0.5 micrometers) and Al layer (thickness of 0.5 micrometers) were formed on two opposite surfaces of the PET film (thickness of 12 micrometers) by vacuum vapor deposition. The Cu layer and the Al layers functioned respectively as the negative current collector and the positive current collector. During the preparation of the Cu layer and the Al layers, a mask was formed to cover a portion of the PVDF film, causing second channels to be formed on the covered portion of the PVDF film. The second channels had an average diameter of 1000 micrometers, the density of the second channels on the composite current collector was 20 /m², and the ratio of the areas of second channels relative to the area of the composite current collector was 16%. Then, the composite current collector was obtained.

Preparation of electrode plate: steps were the same as those of the embodiment 6.

Preparation of electrolyte: steps were the same as those of the embodiment 6.

Preparation of lithium battery: steps were the same as those of the embodiment 6.

### COMPARATIVE EMBODIMENT 1

Preparation of negative electrode plate: graphite, Super P, and SBR, in a ratio of 96:1.5:2.5 by weight, were mixed to form the negative active material. Deionized water was added into the negative active material to form a slurry with a solid content of 70%. The slurry was stirred and then coated on opposite surfaces of a negative current collector (Cu foil), dried at 110 degrees Celsius, and cold pressed to form the negative electrode plate.

Preparation of positive electrode plate: LiCoO₂, Super P, and PVDF, in a ratio of 97.5:1.0:1.5 by weight, were mixed to form the negative active material. NMP was added into the positive active material to form a slurry with a solid content of 75%. The slurry was stirred and then coated on two opposite surfaces of a positive current collector (Al foil), dried at 90 degrees Celsius, and cold pressed to form the positive electrode plate.

Preparation of electrolyte: steps were the same as those of the embodiment 1.

Preparation of lithium battery: a PE film, with a thickness of 15 micrometers, functioned as an isolation film. The positive electrode plate, the isolation film, and the negative film were stacked in that order and wound to form the battery cell. Other steps were the same as those of the embodiment 1.

### COMPARATIVE EMBODIMENT 2

Preparation of composite current collector (having different materials on opposite surfaces of the insulating layer): Cu layer (thickness of 0.5 micrometers) and Al layer (thickness of 0.5 micrometers) were formed on two opposite surfaces of the PET film (thickness of 12 micrometers) by vacuum vapor deposition. The Cu layer and the Al layers functioned respectively as the negative current collector and the positive current collector.

Preparation of electrode plate: steps were the same as those of the embodiment 1.

Preparation of electrolyte: steps were the same as those of the embodiment 1.

Preparation of lithium battery: a PE film, with a thickness of 15 micrometers, functioned as an isolation film. The electrode plate and the isolation film were wound to form the battery cell. Other steps were the same as those of the embodiment 1.

### COMPARATIVE EMBODIMENT 3

Preparation of composite current collector (having different materials on opposite surfaces of the insulating layer): Cu layer (thickness of 0.5 micrometers) and Al layer (thickness of 0.5 micrometers) were formed on two opposite surfaces of the PET film (thickness of 12 micrometers) by vacuum vapor deposition. The Cu layer and the Al layers functioned respectively as the negative current collector and the positive current collector.

Preparation of electrode plate: steps were the same as those of the embodiment 18.

Preparation of electrolyte: steps were the same as those of the embodiment 18.

Preparation of lithium battery: steps were the same as those of the embodiment 18.

The electrochemical properties of each lithium battery prepared by embodiments 1-19 and comparative embodiments 1-3 were tested. The conditions of preparation and the results of testing are shown in Table 1.

TABLE 1

| | | | | | | | | Discharge |
|---|---|---|---|---|---|---|---|---|
| | | Forming | | | | | | capacity after |
| | | manner of | Average | | Ratio of | Ionic | Energy density | 50cycles/initial |
| | Features of | the battery | diameter | Density | areas of the | conductive | undue 0.1C | discharge |
| | electrode plate | cell | (μm) | (/cm2) | channels | material | (Wh/L) | capacity |
| Embodiment 1 | Channels defined in | folded | 50 | 1000 | 2% | PVDF | 646 | 92.1% |
| | composite current | | | | | | | |
| | collector | | | | | | | |
| Embodiment 2 | Channels defined in | folded | 500 | 60 | 12% | PVDF | 713 | 92.0% |
| | composite current | | | | | | | |
| | collector | | | | | | | |
| Embodiment 3 | Channels defined in | folded | 2000 | 10 | 31% | PVDF | 695 | 92.1% |
| | composite current | | | | | | | |
| | collector | | | | | | | |
| Embodiment 4 | Channels defined in | folded | 5000 | 2 | 39% | PVDF | 683 | 92.1% |
| | composite current | | | | | | | |
| | collector | | | | | | | |
| Embodiment 5 | Channels defined in | folded | 2000 | 1 | 3.1% | PVDF | 657 | 92.0% |
| | composite current | | | | | | | |
| | collector | | | | | | | |
| Embodiment 6 | Channels defined in | folded | 1000 | 20 | 16% | PVDF | 716 | 92.1% |
| | composite current | | | | | | | |
| | collector | | | | | | | |
| Embodiment 7 | Channels defined in | folded | 500 | 100 | 20% | PVDF | 711 | 92.2% |
| | composite current | | | | | | | |
| | collector | | | | | | | |
| Embodiment 8 | Channels defined in | folded | 1600 | 1 | 2% | PVDF | 639 | 91.9% |
| | composite current | | | | | | | |
| | collector | | | | | | | |
| Embodiment 9 | Channels defined in | folded | 1600 | 4 | 8% | PVDF | 688 | 92.0% |
| | composite current | | | | | | | |
| | collector | | | | | | | |
| Embodiment | Channels defined in | folded | 1600 | 12 | 24% | PVDF | 705 | 92.1% |
| 10 | composite current | | | | | | | |
| | collector | | | | | | | |
| Embodiment | Channels defined in | folded | 1600 | 20 | 40% | PVDF | 686 | 92.0% |
| 11 | composite current | | | | | | | |
| | collector | | | | | | | |
| Embodiment | Channels defined in | folded | 1000 | 20 | 16% | PAN | 712 | 92.3% |
| 12 | composite current | | | | | | | |
| | collector | | | | | | | |
| Embodiment | Channels defined in | folded | 1000 | 20 | 16% | PEO | 718 | 91.4% |
| 13 | composite current | | | | | | | |
| | collector | | | | | | | |
| Embodiment | Channels defined in | folded | 1000 | 20 | 16% | PVDF + | 713 | 92.0% |
| 14 | composite current | | | | | Al2O3 | | |
| | collector | | | | | | | |
| Embodiment | Channels defined in | folded | 1000 | 20 | 16% | PVDF | 634 | 92.5% |
| 15 | whole electrode | | | | | | | |
| | plate | | | | | | | |
| Embodiment | Channels defined in | folded | 1000 | 20 | 16% | PVDF | 719 | 92.2% |
| 16 | composite current | | | | | | | |
| | collector + primary | | | | | | | |
| | coating | | | | | | | |
| Embodiment | Channels defined in | folded | 1000 | 20 | 16% | PVDF | 708 | 94.4% |
| 17 | composite current | | | | | | | |
| | collector + blank | | | | | | | |
| | areas at opposite | | | | | | | |
| | sides | | | | | | | |
| Embodiment | Channels defined in | stacked | 1000 | 20 | 16% | PVDF | 733 | 92.3% |
| 18 | composite current | | | | | | | |
| | collector | | | | | | | |
| Embodiment | Insulating layer | folded | 1000 | 20 | 16% | PVDF | 714 | 92.1% |
| 19 | including ionic | | | | | | | |
| | conductive material | | | | | | | |
| Comparative | Normal current | wound | / | / | / | / | 623 | 92.3% |
| embodiment 1 | collector | | | | | | | |
| Comparative | Composite current | wound | / | / | / | / | 649 | 92.2% |
| embodiment 2 | collector | | | | | | | |
| Comparative | Composite current | stacked | / | / | / | / | 663 | 92.4% |
| embodiment 3 | collector | | | | | | | |

Table 1 shows that the batteries prepared by embodiments 1-19 have greater energy densities by incorporating the composite current collector (having different materials on opposite surfaces of the insulating layer) into the batteries, and no isolation film is needed. Each of the batteries prepared by embodiments 1-18 and comparative embodiments 2-3 use the composite current collector, but since no isolation film is needed in the batteries prepared by embodiments 1-18, the batteries prepared by embodiments 1-18 will have a greater energy density compared to the batteries prepared by comparative embodiments 2-3. However, the batteries prepared by embodiments 1, 5 and 8 actually have a slightly lower energy density compared to the batteries prepared by comparative embodiments 2-3, due to low ratios of the areas of first channels relative to the area of the composite current collector. The battery prepared by embodiment 15 actually also has a slightly lower energy density compared to the batteries prepared by comparative embodiments 2-3, due to a loss of active materials when the channels are defined in the whole electrode plate. In addition, compared to the battery prepared by embodiment 6, the battery prepared by embodiment 17 has a greater cycling retention capacity since the blank areas are formed on opposite sides of the connecting sections of the battery cell.

It is to be understood, even though information and advantages of the present embodiments have been set forth in the foregoing description, together with details of the structures and functions of the present embodiments, the disclosure is illustrative only; changes may be made in detail, especially in matters of shape, size, and arrangement of parts within the principles of the present embodiments to the full extent indicated by the plain meaning of the terms in which the appended claims are expressed.

What is claimed is:

1. A battery cell comprising:
an electrode plate comprising:
a composite current collector comprising an ionic conductive material; and
two active material layers disposed on the composite current collector and comprising a positive active material layer and a negative active material layer, the composite current collector being disposed between the positive active material layer and the negative active material layer, each of the positive active material layer and the negative active material layer being connected to the ionic conductive material;
wherein the battery cell is a multilayered structure formed by folding a single electrode plate or by stacking a plurality of the electrode plates together, and adjacent active material layers in two adjacent layers of the battery cell are of a same polarity.

2. The battery cell of claim 1, further comprising a plurality of first channels passing through the composite current collector, wherein the ionic conductive material fills in the plurality of first channels.

3. The battery cell of claim 2, wherein the plurality of first channels further pass through the positive active material layer and the negative active material layer.

4. The battery cell of claim 2, wherein an average diameter of the plurality of first channels is between 50 micrometers and 5000 micrometers.

5. The battery cell of claim 2, wherein a density of the plurality of first channels on the composite current collector is between 1 /m² and 1000 /m².

6. The battery cell of claim 2, wherein a ratio of areas of the plurality of first channels with respect to an area of the composite current collector is between 2% and 40%.

7. The battery cell of claim 1, wherein the composite current collector comprises:
an insulating layer;
a first conductive layer; and
a second conductive layer, the insulating layer being disposed between the first conductive layer and the second conductive layer,
wherein the positive active material layer is connected to a surface of the first conductive layer away from the insulating layer, and the negative active material layer is connected to a surface of the second conductive layer away from the insulating layer.

8. The battery cell of claim 7, wherein the insulating layer comprises the ionic conductive material, each of the first conductive layer and the second conductive layer comprises a plurality of second channels; and the positive active material layer and the negative active material layer fill in the plurality of second channels and further connect the insulating layer.

9. The battery cell of claim 1, wherein the battery cell is formed by folding the single electrode plate, and the battery cell is S-shaped.

10. The battery cell of claim 9, further comprising a plurality of connecting sections each disposed between two adjacent active material layers, wherein the plurality of connecting sections comprise no active material layer.

11. The battery cell of claim 1, wherein the battery cell comprises a plurality of electrode plates which are stacked together.

12. The battery cell of claim 1, wherein the ionic conductive material is selected from a group consisting of poly(vinylidene fluoride-hexafluoropropylene), polyvinylidene fluoride, polyacrylonitrile, polymethyl methacrylate, polyphenylene oxide, poly propylene carbonate, polyethylene oxide, and derivatives thereof.

13. A battery cell comprising:
a battery cell;
an electrolyte; and
a package casing configured for receiving the battery cell and the electrolyte;
the battery cell comprising an electrode plate, the electrode plate comprising:
a composite current collector comprising an ionic conductive material; and
two active material layers disposed on the composite current collector, the two active material layers comprising a positive active material layer and a negative active material layer, the composite current collector being disposed between the positive active material layer and the negative active material layer, each of the positive active material layer and the negative active material layer being connected to the ionic conductive material;
wherein the battery cell is a multilayered structure formed by folding a single electrode plate or by stacking a plurality of the electrode plates together, adjacent active material layers in two adjacent layers of the battery cell are of a same polarity.

14. The battery of claim 13, wherein the battery cell further comprises a plurality of first channels passing through the composite current collector, wherein the ionic conductive material fills in the plurality of first channels.

15. The battery of claim 14, wherein the plurality of first channels further pass through the positive active material layer and the negative active material layer.

16. The battery of claim 14, wherein an average diameter of the plurality of first channels is between 50 micrometers and 5000 micrometers.

17. The battery of claim 14, wherein a density of the plurality of first channels on the composite current collector is between 1 /m² and 1000 /m².

18. The battery of claim 14, wherein a ratio of areas of the plurality of first channels with respect to an area of the composite current collector is between 2% and 40%.

19. The battery of claim 13, wherein the composite current collector comprises:
an insulating layer;
a first conductive layer; and
a second conductive layer, the insulating layer being disposed between the first conductive layer and the second conductive layer,
wherein the positive active material layer is connected to a surface of the first conductive layer away from the insulating layer, and the negative active material layer is connected to a surface of the second conductive layer away from the insulating layer.

20. The battery cell of claim 19, wherein the insulating layer comprises the ionic conductive material, each of the first conductive layer and the second conductive layer comprises a plurality of second channels; and the positive active material layer and the negative active material layer fill in the plurality of second channels and further connect the insulating layer.
